(19) United States
(12) Patent Application Publication
(10) Pub. No.: US 2016/0189098 A1
(43) Pub. Date: Jun. 30, 2016

(54) METHOD AND APPARATUS FOR PROVIDING ACCESS TO CONTEXTUALLY RELEVANT VEHICLES FOR DELIVERY PURPOSES

(71) Applicant: HERE Global B.V., Veldhoven (NL)

(72) Inventors: Jerome BEAUREPAIRE, Berlin (DE); Marko Tapio TUUKKANEN, Schlenzer (DE)

(21) Appl. No.: 14/586,026

(22) Filed: Dec. 30, 2014

(51) Int. Cl. G06Q 10/08; G07C 9/00

(52) U.S. Cl. CPC G06Q 10/0835; G07C 9/00166; G06Q 50/01

(57) ABSTRACT

An approach is provided for selecting at least one vehicle nearby a delivery location that can accept delivery of an item for a user. The approach involves determining a request for at least one delivery of at least one item to at least one delivery location associated with at least one user. The approach also involves determining one or more vehicles that are capable of accepting the at least one delivery of the at least one item as a substitute to the at least one delivery location. The approach further involves causing, at least in part, a selection of at least one vehicle from the one or more vehicles. The approach also involves causing, at least in part, a granting of an access to the at least one selected vehicle for accepting the at least one delivery of the at least one item.

### BACKGROUND

Service providers and device manufacturers (e.g., wireless, cellular, etc.) are continually challenged to deliver value and convenience to consumers by, for example, providing compelling network services. One area of interest has been timely and secure delivery of goods to the intended purchasers despite their absence. However, service providers encounter multiple difficulties while delivering goods to recipients not available at the delivery location (e.g., lack of safe area to leave the goods, possibility of theft of the goods, etc.). Accordingly, there is a need for a service that ensures secure and flexible delivery method.

### SOME EXAMPLE EMBODIMENTS

Therefore, there is a need for an approach for selecting at least one vehicle nearby a delivery location that can accept delivery of an item for a user.

According to one embodiment, a method comprises determining a request for at least one delivery of at least one item to at least one delivery location associated with at least one user. The method also comprises determining one or more vehicles that are capable of accepting the at least one delivery of the at least one item as a substitute to the at least one delivery location. The method further comprises causing, at least in part, a selection of at least one vehicle from the one or more vehicles. The method also comprises causing, at least in part, a granting of an access to the at least one selected vehicle for accepting the at least one delivery of the at least one item.

According to another embodiment, an apparatus comprises at least one processor, and at least one memory including computer program code for one or more computer programs, the at least one memory and the computer program code configured to, with the at least one processor, cause, at least in part, the apparatus to determine a request for at least one delivery of at least one item to at least one delivery location associated with at least one user. The apparatus is also caused to determine one or more vehicles that are capable of accepting the at least one delivery of the at least one item as a substitute to the at least one delivery location. The apparatus is further caused cause, at least in part, a selection of at least one vehicle from the one or more vehicles. The apparatus is also caused to cause, at least in part, a granting of an access to the at least one selected vehicle for accepting the at least one delivery of the at least one item.

According to another embodiment, a computer-readable storage medium carries one or more sequences of one or more instructions which, when executed by one or more processors, cause, at least in part, an apparatus to determine a request for at least one delivery of at least one item to at least one delivery location associated with at least one user. The apparatus is also caused to determine one or more vehicles that are capable of accepting the at least one delivery of the at least one item as a substitute to the at least one delivery location. The apparatus is further caused to cause, at least in part, a selection of at least one vehicle from the one or more vehicles. The apparatus is also caused to cause, at least in part, a granting of an access to the at least one selected vehicle for accepting the at least one delivery of the at least one item.

According to another embodiment, an apparatus comprises means for determining a request for at least one delivery of at least one item to at least one delivery location associated with at least one user. The apparatus also comprises means for determining one or more vehicles that are capable of accepting the at least one delivery of the at least one item as a substitute to the at least one delivery location. The apparatus further comprises means for causing, at least in part, a selection of at least one vehicle from the one or more vehicles. The apparatus also comprises means for causing, at least in part, a granting of an access to the at least one selected vehicle for accepting the at least one delivery of the at least one item.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of selecting at least one vehicle nearby a delivery location that can accept delivery of an item for a user, according to one embodiment;

FIG. 2 is a diagram of the components of a configuration platform, according to one embodiment;

FIG. 3 is a flowchart of a process for granting access to at least one proximate vehicle capable of accepting delivery of an item, according to one embodiment;

FIG. 4 is a flowchart of a process for determining the type of access to be granted based on subscription status information associated with a car sharing service, according to one embodiment;

FIG. 5 is a flowchart of a process for selecting vehicles based on location information, according to one embodiment;

FIG. 6 is a flowchart of a process for determining vehicles based, at least in part, on scheduling information and/or calendar information and/or user location and/or vehicle information, according to one embodiment;

FIG. 7 is a flowchart of a process for determining vehicles based on the characteristics of the items, according to one embodiment;

FIGS. 8A and 8B are sequence diagrams utilized in the process of providing delivery of an item via established communication between an ecommerce website, a parcel delivery company, a parcel delivery person equipped with a parcel tracking/reading device, a car sharing service, a shared car, the configuration platform 109, and the UE 101 of the user, according to one example embodiment;

FIGS. 9A and 9B are ladder diagrams utilized in the process of providing delivery of an item via established communication between an ecommerce website, a delivery company, a parcel delivery person equipped with a parcel tracking/reading device, a vehicle of a social networking contact of a user, the UE 101 of the user, and the configuration platform 109, according to one example embodiment;

FIG. 10A is a user interface diagram that represents a scenario wherein vehicle sharing services may be utilized to deliver items to nearby vehicles instead of the delivery location, according to one example embodiment;

FIG. 10B is a user interface diagram that represents a scenario wherein vehicles proximate to a delivery location are queried on availability, according to one example embodiment;

FIG. 10C is a user interface diagram that represents a scenario wherein at least one user is notified of delivery of an item, according to one example embodiment;

FIG. 11 is a diagram of hardware that can be used to implement an embodiment of the invention;

FIG. 12 is a diagram of a chip set that can be used to implement an embodiment of the invention; and

FIG. 13 is a diagram of a mobile terminal (e.g., handset) that can be used to implement an embodiment of the invention.

### DESCRIPTION OF SOME EMBODIMENTS

Examples of a method, apparatus, and computer program for selecting at least one vehicle nearby a delivery location that can accept delivery of an item for a user are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

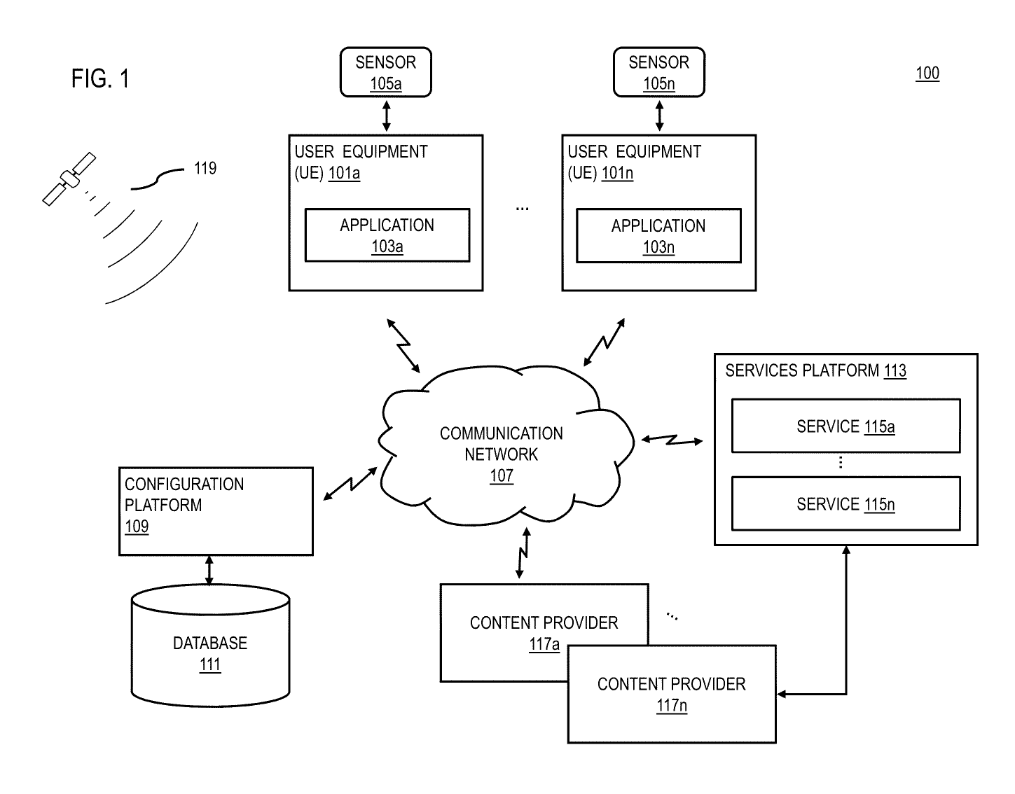

FIG. 1 is a diagram of a system capable of selecting at least one vehicle nearby a delivery location that can accept delivery of an item for a user, according to one embodiment. Generally, a user provides an address or location for delivery of good or items purchased. For example, the user may purchase an item from an online or ecommerce site and order it for delivery to a home address. The delivery to the location is generally provided by delivery or courier services provider. In a case, when the user is not available to receive the delivery at the delivery location, then the item may be delivered to a neighbor, placed at a post office or a packstation, returned to a merchant or a seller, or held in a warehouse till it is picked by the user. However, the user may not be willing to give the item to the neighbor. Further, picking the item from other locations may be inconvenient and time consuming. As a result, there is a need for a method wherein at least one delivery of at least one item to at least one delivery location associated with at least one user is provided to one or more vehicles on behalf of the at least one user.

To address this problem, a system 100 of FIG. 1 introduces a solution that allows the receiving of delivery of items by using vehicles. Various car sharing service providers enable users to share the cars. For example, a car parked at a parking location by the service provider or at any location, such a street parking, can be booked by the user. Accordingly, the user may be granted access to the car for driving or accessing a part of the car (e.g., a trunk, a glove compartment, etc.). Further, these cars are generally remotely connected to the service provider and thus can be configured remotely for driving or use. Typically, such cars can be booked by using the Internet (e.g., through online booking web portals) and therefore, provide a convenient way for the user to avail these services. Accordingly, these cars may be used for receiving delivery of the item on behalf of the user. In one embodiment, the car or vehicles are associated with at least one car sharing service, at least one social networking contact of at least one user, one or more autonomous vehicles, or a combination thereof. In one example embodiment, a user may live far-off from his/her office, hence the user is never home at the time usual deliveries are done. Thus, the user needs to either reschedule the delivery time, or pick the delivery from the post office, which unfortunately is also open from 8 a.m. till 5 p.m. (i.e., the timing clashes with the office timing of the user). As a result, receiving the delivery can be delayed by multiple days because the user can only pick-up the delivery from the post office on weekends. The most convenient option for the user would be to have the delivery done to his/her car, which is usually parked at the train station where he/she transit to work. This location is also optimal for delivery companies since they tend to have their branch offices nearby.

As shown in FIG. 1, the system 100 comprises user equipment (UE) 101a-101n (collectively referred to as UE 101) that may comprise or be associated with applications 103a-103n (collectively referred to as applications 103) and sensors 105a-105n (collectively referred to as sensors 105). In one embodiment, the UE 101 has connectivity to a configuration platform 109 via the communication network 107. In one embodiment, the configuration platform 109, for example a car sharing service, performs one or more functions associated with providing delivery of the item by using vehicles, and granting a user and/or the delivery service provider and/or a parcel delivery person an access to those vehicles. By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.). In one embodiment, the one or more vehicles may have cellular or Wi-Fi connection either through the inbuilt communication equipment or from the UE 101 associated/embedded with the vehicles. The applications 103 may assist in conveying sensor information via the communication network 107. In one scenario, the one or more vehicles are associated with a car sharing service.

By way of example, the applications 103 may be any type of application that is executable at the UE 101, such as location-based service applications, navigation applications, mapping application, content provisioning services, camera/imaging application, media player applications, social networking applications, a parcel tracking/reading applications, calendar applications, and the like. In one embodiment, one of the applications 103 at the UE 101 may act as a client for the configuration platform 109 and perform one or more functions associated with the functions of the configuration platform 109 by interacting with the configuration platform 109 over the communication network 107. In one scenario, the applications 103 may determine one or more contacts of the user from social networks. In another scenario, the applications 103 may determine the current schedule of the user from the calendar of the user. By way of example, the calendar may be a local calendar stored on the UE 101 or provided by a cloud based service. Further, in a scenario, the applications 103 provide notifications to the user about the delivery of the item to a delivery location. For example, displayed notification may comprise the time and place or address of the delivery. In one scenario, the applications 103 may be an authenticating application for granting access to one or more vehicles based on a validation mechanism. In another scenario, the applications 103 may be a location based application interfacing with the services platform 113 via the communication network 107 for accessing turn-by-turn navigation, routing information, maps, driving instructions, etc. to the item delivery location. In another scenario, the vehicle used to receive the delivery may be equipped with a camera. The camera may be used for recording and/or communication, for example, the recipient of the delivery may be connected to the camera to confirm that goods have been delivered to the vehicle. In addition, the camera may be used to verify the delivered package (e.g., size, form, weight, etc.). Further, the camera may also be used to record the delivery, and the recording may be shared with the delivery company as a proof of delivery, for example, the person doing the delivery may present the package to the camera while placing it in the trunk of the vehicle. The recording may be later accessed by the delivery company, the recipient, or the owner of the vehicle. The vehicle may also be able to send a delivery message to the user when a delivery has been received. In a further scenario, the application 103 may be a parcel tracking/reading device carried by a delivery person, the parcel tracking/reading device possesses information on the item, about the one or more nearby cars (e.g., car's location, type, color, license plate, etc.).

By way of example, the sensors 105 may be any type of sensor. In certain embodiments, the sensors 105 may include, for example, a global positioning sensor for gathering location data (e.g., GPS may monitor the movement of the delivering vehicle), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, a parcel tracking sensor for tracking the parcel movement, and the like. In one example embodiment, the UE 101 may include one or more GPS receivers to obtain geographic coordinates from satellites 119 for determining current location and time associated with the UE 101.

The communication network 107 of system 100 comprises one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the configuration platform 109 may be a platform with multiple interconnected components. The configuration platform 109 may comprise multiple services/servers, for example car sharing service, rental car service, social networking service, intelligent networking devices, computing devices, components and corresponding software for detecting available vehicles, granting access, at least in part, to those vehicles, and providing notifications regarding the delivery, or any combination thereof. In addition, it is noted that the configuration platform 109 may be a separate entity of the system 100, a part of the one or more services 115a-115n (collectively referred to as services 115) of the services platform 113, or included within the UE 101 (e.g., as part of the applications 103).

In one embodiment, the configuration platform 109 may receive a delivery request from a user (e.g. a customer of an ecommerce service) and/or from an ecommerce service associated with the user for delivery of at least one item to a delivery location associated with and/or defined by the user. Then, the configuration platform 109 may determine the one or more vehicles that are capable of accepting the at least one delivery of the at least one item as a substitute to the at least one delivery location. For example, the configuration platform 109 may determine the availability of vehicles from a car sharing service, a social contact of the user, or an autonomous vehicle, etc. or any combination thereof. In one embodiment, the configuration platform 109 determines the one or more vehicles based, at least in part, on a proximity to the delivery location, a current location of the user, a future location of the user, or a combination thereof. As noted previously, the current location or a future location of the user may be determined by the applications 103 at least in part, on scheduling information, calendar information, positioning device location information (105), or a combination thereof. In one embodiment, the configuration platform 109 determines the one or more vehicles based, at least in part, on scheduling information, calendar information, positioning device location information (105), or a combination thereof associated with the vehicles, at least one owner of the vehicles, or a combination thereof. Therefore, the scheduling information, the calendar information, positioning device location information (105), or a combination thereof for the vehicle or the owners coincides with an anticipated delivery time. By way of example, the configuration platform 109 may determine cars of friends (e.g., from social networking) of the user are in proximity to the current location of the user or in proximity to the delivery location. In this case, the configuration platform 109 determines the scheduling and/or calendar information of the friends of the user to determine a vehicle for receiving the delivery. In one embodiment, the configuration platform 109 determines the vehicles to be used for the delivery based on one or more characteristics of the item. The characteristics may comprise, for example, a price, a size, fragility, perishability, or a combination thereof of the item.

In one embodiment, the configuration platform 109 may grant an access to the vehicle for accepting the delivery of the at least one item on behalf of the at least one user. In one embodiment, the access includes, at least in part, an access to one or more compartments of the vehicles without an access to operate the vehicles. For example, the access may be granted only for a trunk of the vehicle, so that item may be placed in the trunk but no access to operate the vehicle may be provided. In one embodiment, the configuration platform 109 determines subscription status (e.g., subscription duration, start time of subscription, end time of subscription, payment mode etc.) information associated with a car sharing service for the user. Accordingly, the access is granted as discussed above.

In one embodiment, the configuration platform 109 initiates the delivery of the item based on a determination that the user is not located at the at the delivery location. As noted previously, the current location of the user may be detected by using the information from the sensor 105. In one embodiment, the configuration platform 109 relays the delivery of the item from one vehicles to another vehicle, if the vehicle moves, becomes unavailable, or a combination thereof. For example, in case a vehicle that received the delivery is to be moved to some other location by the owner of the vehicle (e.g., a social networking friend of the user), then the item may be relayed to another vehicle. In one embodiment, another vehicle for receiving the delivery may be determined by the configuration platform 109 based on the processes as discussed above.

In one embodiment, the database 111 may store profile information, items information and/or location based information for specific users from the sensors 105, the configuration platform 109, the services platform 113 and/or one or more content providers 117a-117n (collectively referred to as content provider 117). The information may be any multiple types of information that can provide means for aiding in the content provisioning and sharing process. In another embodiment, the database 111 may store routing and/or navigation information towards one or more points of interest. In one scenario, profile information for one or more user (e.g., a customer of an ecommerce site) may be recorded in the database 111. The profile information may comprise details of a service contract of the user with the content provider 117, details of a service contract of the user with the service platform 113, details of a service contract of the user with the configuration platform 109, details of friends of the user, vehicle type of size owned by the user or friends, general location of the vehicle, etc. or any combination thereof. In one scenario, the general location may include the home or office parking space of the user or the contact/friend/family of the user.

The services platform 113 may include any type of service. By way of example, the services platform 113 may include several services 115, for example mapping services, navigation services, delivery services, car sharing services, rental car services, travel planning services, social networking services, content (e.g., audio, video, images, etc.) provisioning services, application services, storage services, contextual information determination services, location based services, information (e.g., weather, news, etc.) based services, etc. or any combination thereof. In one embodiment, the services platform 113 may interact with the UE 101, the configuration platform 109 and the content provider 117 to supplement or aid in the processing of the content information.

By way of example, the services 115 may be an online service that reflects interests and/or activities of users. In one scenario, the services 115 provide representations of each user (e.g., a profile), his/her social links, and a variety of additional information. The services 115 allow users to share location information, activities information, contextual information, historical user information and interests within their individual networks, and provides for data portability. The services 115 may additionally assist in providing the configuration platform 109 with travel information of the one or more geo-routes and/or location anchors, etc. By way of another example, the services 115 may be a car sharing service that provides vehicles for rent to the user. In one scenario, the services 115 provide the information regarding the availability and location of the vehicle. Additionally, the services 115 may enable the user to provide access to the vehicle for receiving the delivery of the item. Further, the services 115 may provide notifications or alerts, subscription status information related to the delivery to the user, the social networking contact, a seller, the delivery service provider or a combination thereof.

The content provider 117 may provide content to the UE 101, the configuration platform 109, and the services 115 of the services platform 113. The content provided may be any type of content, such as textual content, audio content, video content, image content, web content, etc. In one embodiment, the content provider 117 may provide content that may supplement content of the applications 103, the sensors 105, or a combination thereof. By way of example, the content provider 117 may provide content that may aid in the processing of profile information, location information, or a combination thereof. In one embodiment, the content provider 117 may also store content associated with the UE 101, the configuration platform 109, and the services 115 of the services platform 113. In another embodiment, the content provider 117 may manage access to a central repository of data, and offer a consistent, standard interface to data, such as a repository of users' profile information, navigational data content etc. Any known or still developing methods, techniques or processes for generating, retrieving and/or accessing location information and/or profile information from one or more sources may be employed by the configuration platform 109.

By way of example, the UE 101, the configuration platform 109, the services platform 113, and the content provider 117 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

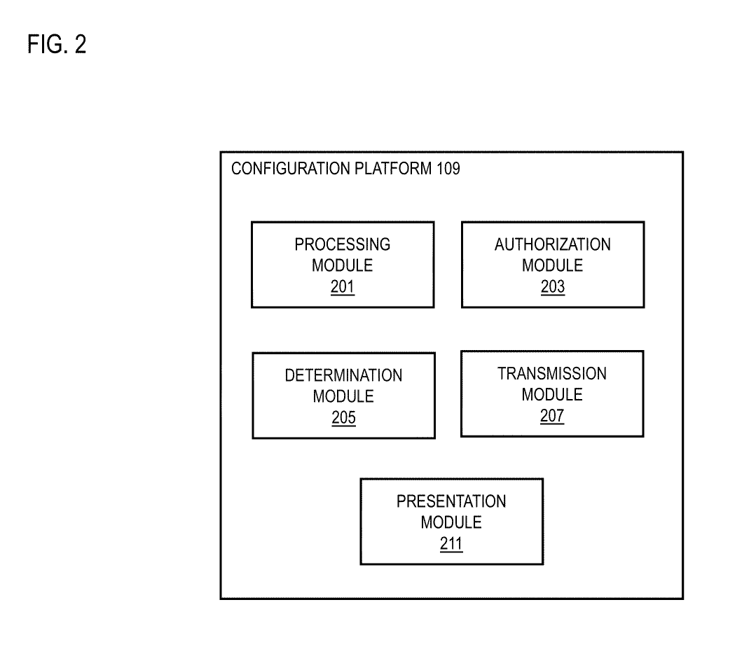

FIG. 2 is a diagram of the components of the configuration platform 109, according to one embodiment. By way of example, the configuration platform 109 includes one or more components for selecting at least one vehicle nearby a delivery location that can accept delivery of an item for a user. In this embodiment, the configuration platform 109 includes a processing module 201, an authorization module 203, a determination module 205, a transmission module 207, a calculation module 209, and a presentation module 211. It is contemplated that the functions of these components may be combined in one or more components or performed by other components of equivalent functionality.

In one embodiment, the processing module 201 may receive a request for at least one delivery of at least one item to at least one delivery location associated with at least one user. The processing module 201 may process the delivery request to determine the details related to the delivery location (e.g., receiver/user identification, address, street, time of delivery, date of delivery etc.). Further, the processing module 201 may process the delivery request to determine the one or more characteristics of the item to be delivered. For example, the characteristics of the item include, at least in part, a price, a size, weight, fragility, perishability, or a combination thereof. In one embodiment, the processing module 201 may determine the current location of the user, future location of the user, or a combination thereof based on scheduling information, calendar information, or a combination thereof. As noted previously, the location information, scheduling information or calendar information may be provided by the UE 101. In one embodiment, the processing module 201 may determine one or more social networking contacts of the user. Further, the processing module 201 may determine the vehicle owned by the user and the social networking contacts of the user. Additionally, the processing module 201 may determine a relationship between the user and other users (e.g., the social networking contacts). For example, the other users may be friends, family members, or neighbors, etc. of the user.

In one embodiment, the determination module 205 may determine one or more vehicles that are capable of accepting the at least one delivery of the at least one item as a substitute to the at least one delivery location. For example, the vehicles may be associated with at least one car sharing service, at least one social networking contact of at least one user, one or more autonomous vehicles, at least a rental car service, or a combination thereof. In one embodiment, the determination module 205 may determine the one or more vehicles based on a proximity to the at least one delivery location, at least one current location of the at least one user, at least one future location of the at least one user, or a combination thereof. By way of example, the vehicles that are within 300 meters of the user's location, or the delivery location, are determined.

In one embodiment, the determination module 205 may determine a subscription status information associated with the at least one car sharing service for the at least one user. As noted previously, the subscription status information includes, for example, subscription duration, start time of subscription, end time of subscription, payment mode etc. Further, the determination module 205 determines which of the one or more vehicles associated with the at least one car sharing service, the at least one social networking contact of at least one user, the one or more autonomous vehicles, or a combination thereof to use for the at least one delivery based on the characteristics of the at least one item. In one embodiment, the determination module 205 may determine the vehicle based on the scheduling information, the calendar information, or a combination thereof associated with the vehicles, the owner of the vehicles, or a combination thereof. Further, this scheduling information, the calendar information, or a combination thereof coincides with an anticipated delivery time.

In one embodiment, the authorization module 203 may grant an access to the one or more vehicles for accepting the at least one delivery of the at least one item on behalf of the at least one user. Further, the authorization module 203 determines a type of access to be granted based, at least in part, on the subscription status information. The type of access includes, for example, an access to the one or more compartments of the one or more vehicles without an access to operate the one or more vehicles. Further, the authorization module 203 initiates the delivery of the at least one item to the one or more vehicle based on a determination that the at least one user is not located at the at least one delivery location. In one embodiment, the authorization module 203 module may operate in relation to the processing module 201 and the determination module 205 to cause a relay of the delivery of the item from the vehicle to one or more other vehicles if the vehicles moves, becomes unavailable, or a combination thereof. As noted previously, the vehicle may be moved to some other location by the owner of the vehicle (e.g., from parking lot of home to that of office).

In one embodiment, the transmission module 207 may cause a transmission of one or more alerts or notifications to the user, the car sharing service, the social networking contact of the user, one or more autonomous vehicles, parcel delivery service, parcel delivery person, or a combination thereof. For example, the notifications may include information related to the delivery of the item. In another embodiment, the transmission module 207 may transmit the determined information received from the determination module 205 to the configuration platform 109, whereupon the configuration platform 109 may provide the delivery of the item.

In one embodiment, the presentation module 211 may cause a presentation of the notification generated by the transmission module 207. In another embodiment, the presentation module 211 may cause a presentation of the progression information for the delivery of the item (e.g., estimated remaining time or distance, the details of the vehicle selected, the subscription status of user etc.). In one embodiment, the configuration platform 109 may process information received from the service platform 113, the service 115, the content provider 117 and other third party content providers to determine items of interest for users in a specific geo-fenced area. Then, the configuration platform 109 may predict the items users in a specific geo-fenced area may purchase in the near future. In one example embodiment, this method of predicting items of interest for users may generate new marketing tactics, for example, the configuration platform 109 may cause notifications to multiple customers within a certain geo-fenced area that ‘the last phone X has been delivered to a vehicle ID YYY and if you purchase it online, you can pick the phone X from vehicle ID YYY on your way home, however only the first few purchasers can get the phone.”

The above presented modules and components of the configuration platform 109 can be implemented in hardware, firmware, software, or a combination thereof. Though depicted as a separate entity in FIG. 1, it is contemplated that the configuration platform 109 may be implemented for direct operation by respective UE 101. As such, the configuration platform 109 may generate direct signal inputs by way of the operating system of the UE 101 for interacting with the applications 103. In another embodiment, one or more of the modules 201-211 may be implemented for operation by respective UEs, the configuration platform 109, or combination thereof. Still further, the configuration platform 109 may be integrated for direct operation with services 115, such as in the form of a widget or applet, in accordance with an information and/or subscriber sharing arrangement. The various executions presented herein contemplate any and all arrangements and models.

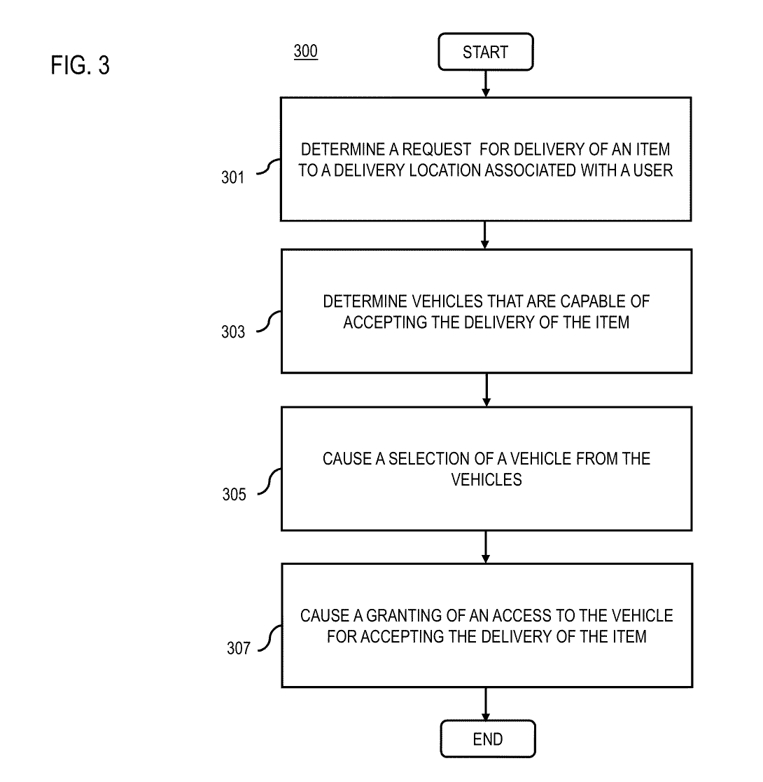

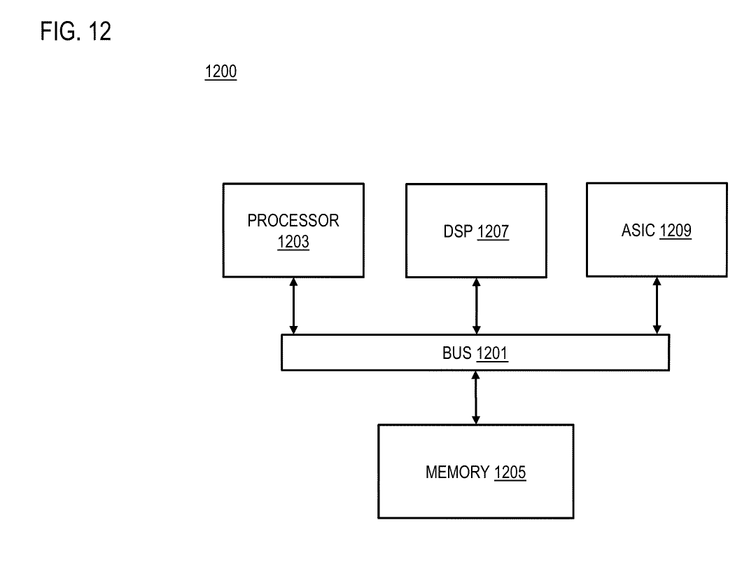

FIG. 3 is a flowchart of a process for granting access to at least one proximate vehicle capable of accepting delivery of an item, according to one embodiment. In one embodiment, the configuration platform 109 performs the process 300 and is implemented in, for instance, a chip set including a processor and a memory as shown in FIG. 12.

In step 301, the configuration platform 109 receives a request for at least one delivery of at least one item to at least one delivery location associated with at least one user. In one scenario, item may be purchased by a user and is to be delivered to a delivery location by a delivery services provider, e.g. parcel delivery vehicle and/or parcel delivery person equipped with a communication device 101.

In step 303, the configuration platform 109 determines the one or more vehicles that are capable of accepting the at least one delivery of the at least one item as a substitute to the at least one delivery location. For example, the configuration platform 109 may determine the availability of vehicles from a car sharing service, a car rental service, a social contact of the user, or an autonomous vehicle, etc. In one scenario, the configuration platform 109 may enforce user to user purchase system, wherein a purchaser who buys goods online may directly pick the good from vendor's vehicle.

In step 305, the configuration platform 109 causes, at least in part, a selection of at least one vehicle from the one or more vehicles. In one scenario, the configuration platform 109 may select a vehicle capable of accepting the delivery of an item from a pool of vehicles based, at least in part, on location information (e.g., proximity), temporal information (e.g., the urgency of receiving the item (e.g., medicines)), cost information (e.g., cheapest alternative for the users), etc. In another scenario, the configuration platform 109 may select a vehicle capable of accepting the delivery of an item from a pool of vehicles based, at least in part, on the attributes of the item of delivery (e.g., the value, the size, the weight, etc.). In one scenario, the configuration platform 109 may consider one or more vehicles that have technical issues (e.g., no battery power, engine failure, punctured tires, etc.) and is not fit for driving for storing the items of delivery. In another scenario, the configuration platform 109 may consider vehicles that are not fit for driving due to pending technical review for temporary holding of one or more delivered goods. In a further scenario, the configuration platform 109 may consider vehicles whose drivers have lost their driving license for storing one or more items of delivery.

In step 307, the configuration platform 109 grants an access to the vehicle for accepting the delivery of the at least one item. In one embodiment, the access includes, at least in part, an access to one or more compartments of the vehicles without an access to operate the vehicles. For example, the access may be granted only for a trunk of the vehicle, so that item may be placed in the trunk but no access to operate the vehicle may be provided. Further, the information related to the delivery may be presented to the user. For example, the information may be presented on a UE 101 associated with the user. In one scenario, if a vehicle is receiving multiple deliveries from different people in the same day, the configuration platform 109 may unlock specific compartment of the vehicle for the intended delivery personnel. In such manner, the configuration platform 109 ensures safety of the stored items, and increases efficiency and convenience.

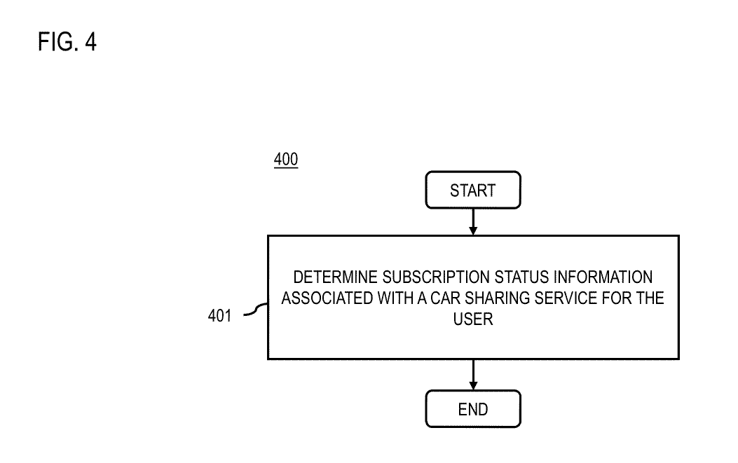

FIG. 4 is a flowchart of a process for determining the type of access to be granted based on subscription status information associated with a car sharing service, according to one embodiment. In one embodiment, the configuration platform 109 performs the process 400 and is implemented in, for instance, a chip set including a processor and a memory as shown in FIG. 12.

In step 401, the configuration platform 109 determines subscription status information associated with a car sharing service for the user. As noted previously, the subscription status information may include, for example, a subscription duration, start time of subscription, end time of subscription, payment mode, access rights, etc. of the car sharing service. In one embodiment, the granting of the access to the one or more vehicles, the at least one delivery of the at least one item, or a combination thereof is based, at least in part, on the subscription status information to the delivery services provider, e.g. the parcel delivery vehicle and/or parcel delivery person equipped with a communication device 101. In another embodiment, the configuration platform 109 determines a type of access to be granted based, at least in part, on the subscription status information. As noted previously, the type of access includes, for example, an access to the one or more compartments of the one or more vehicles without an access to operate the one or more vehicles

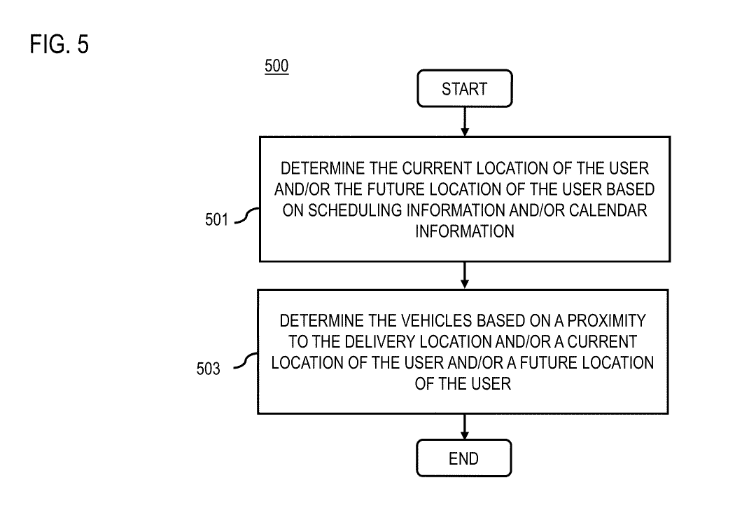

FIG. 5 is a flowchart of a process for selecting vehicles based on location information, according to one embodiment. In one embodiment, the configuration platform 109 performs the process 500 and is implemented in, for instance, a chip set including a processor and a memory as shown in FIG. 12.

In step 501, the configuration platform 109 determines a current location of the at least one user, the at least one future location of the at least one user, or a combination thereof. In one embodiment, the determination of the locations is based, at least in part, on scheduling information, calendar information, positioning device location information (105), or a combination thereof. As noted previously, the current location or a future location of the user may be determined by the applications 103 or sensors 105 at least in part, on scheduling information, calendar information, or a combination thereof.

Per step 503, the configuration platform 109 determines the one or more vehicles based, at least in part, on a proximity to the delivery location, a current location of the user, a future location of the user, or a combination thereof. By way of example, a vehicle that is within a predefined distance threshold (e.g., 300 meters) of the user's current location, or from the delivery location, is selected for the delivery. Accordingly, the configuration platform 109 grants an access to the vehicle for accepting the delivery of the at least one item on behalf of the at least one user. Further, the information related to the delivery may be presented to the user. For example, the information may be presented on a UE 101 associated with the user.

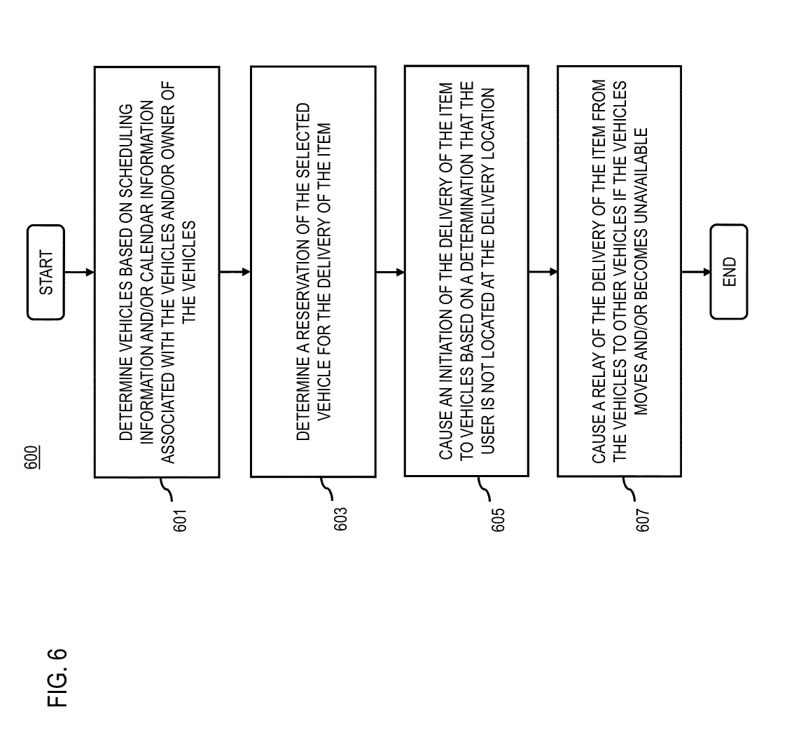

FIG. 6 is a flowchart of a process for determining vehicles based, at least in part, on scheduling information and/or calendar information and/or user location and/or vehicle information, according to one embodiment. In one embodiment, the configuration platform 109 performs the process 600 and is implemented in, for instance, a chip set including a processor and a memory as shown in FIG. 12.

In step 601, the configuration platform 109 determines the one or more vehicles based, at least in part, on scheduling information, calendar information, positioning device location information (105), or a combination thereof associated with the vehicles, at least one owner of the vehicles, or a combination thereof. By way of example, a vehicle of a social networking contact is selected based on the calendar of the owner of that vehicle. For example, if it is determined from the calendar information that the vehicle will not be available after a predefined time threshold (e.g., 2 hours) from the current time, and the delivery time is anticipated to be less than 1 hour, then that vehicle is selected for delivery. Accordingly, the configuration platform 109 grants an access to the vehicle for accepting the delivery of the at least one item on behalf of the at least one user. Further, the information related to the delivery may be presented to the user. For example, the information may be presented on a UE 101 associated with the user. In one scenario, the value of delivered goods may impact the location and the vehicle used for storage. A highly valuable item may only be stored in a privately owned vehicle. Further, the size and the form of a vehicle may also impact the choice, for example, a vehicle with a closed trunk may be preferred over a vehicle with a window on the back. In addition, the location of the vehicle may also impact the choice, for example, a vehicle parked on a private property may be preferred over a vehicle parked on a public street. In a further scenario, the context and the property of a car may be used during selection, for example, car temperature and/or location of the car (e.g., car under shadow with better isolation) may be chosen for perishable goods.

In step 603, the configuration platform 109 determines a reservation of the at least one selected vehicle for the at least one delivery of the at least one item. In one scenario, the configuration platform 109 reserves one of the nearby cars for the delivery of an item. In another scenario, the configuration platform 109 reserves a car based on the attributes of the item of delivery. In one example embodiment, the configuration platform 109 may reserve at least one vehicle with bad winter tires during bad weather conditions (e.g., snow storm) for collecting items of delivery rather than delivering the goods.

In step 605, the configuration platform 109 causes, at least in part, an initiation of the at least one delivery of the at least one item to the one or more vehicles based, at least in part, on a determination that the at least one user is not located at the at least one delivery location. In one scenario, the configuration platform 109 may authorize delivery of goods to one or more contextually relevant vehicles (e.g., vehicles proximate to the delivery location) in the absence of the user in the delivery location.

In step 607, the configuration platform 109 causes, at least in part, a relay of the at least one delivery of the at least one item from the one or more vehicles to one or more other vehicles if the one or more vehicles moves, becomes unavailable, or a combination thereof. For example, in case a vehicle that received the delivery is to be moved to some other location by the owner of the vehicle (e.g., a social networking friend of the user), and then the item may be relayed to another proximate vehicle.

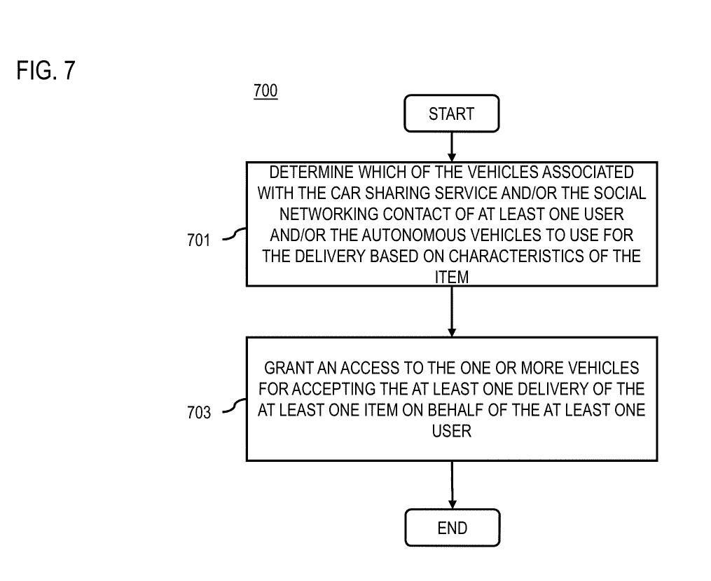

FIG. 7 is a flowchart of a process for determining vehicles based on the characteristics of the items, according to one embodiment. In one embodiment, the configuration platform 109 performs the process 700 and is implemented in, for instance, a chip set including a processor and a memory as shown in FIG. 12.

Per step 701 of process 700 (FIG. 7), the configuration platform 109 determines the vehicles to be used for the delivery based on one or more characteristics of the item. The characteristics may include, for example, a price, a size, weight, fragility, perishability, or a combination thereof of the item.

In step 703, the configuration platform 109 grants an access to the vehicle for accepting the delivery of the at least one item on behalf of the at least one user, based on the characteristics. In one scenario, the access is granted based on the price of the item. For example, if the price of the item is less than $10, then a vehicle of any social networking contact may be selected, however, if the prices is between $10 and $200, vehicles of only close social networking contact are selected, and further vehicles of only family members are selected if the price is more than $200. In another scenario, the access is granted based on the size of the item. For example, if the size of the item is less than the dimensions of the trunk of the vehicle, then the access is granted to only the trunk and not to the rest of the vehicle. However, if the size of the item is bigger than that of the trunk, or there are more than one items that cannot be accommodated in the trunk then the access to other parts of the vehicle may be granted. Further, the information related to the delivery may be presented to the user. For example, the information may be presented on a UE 101 associated with the user.

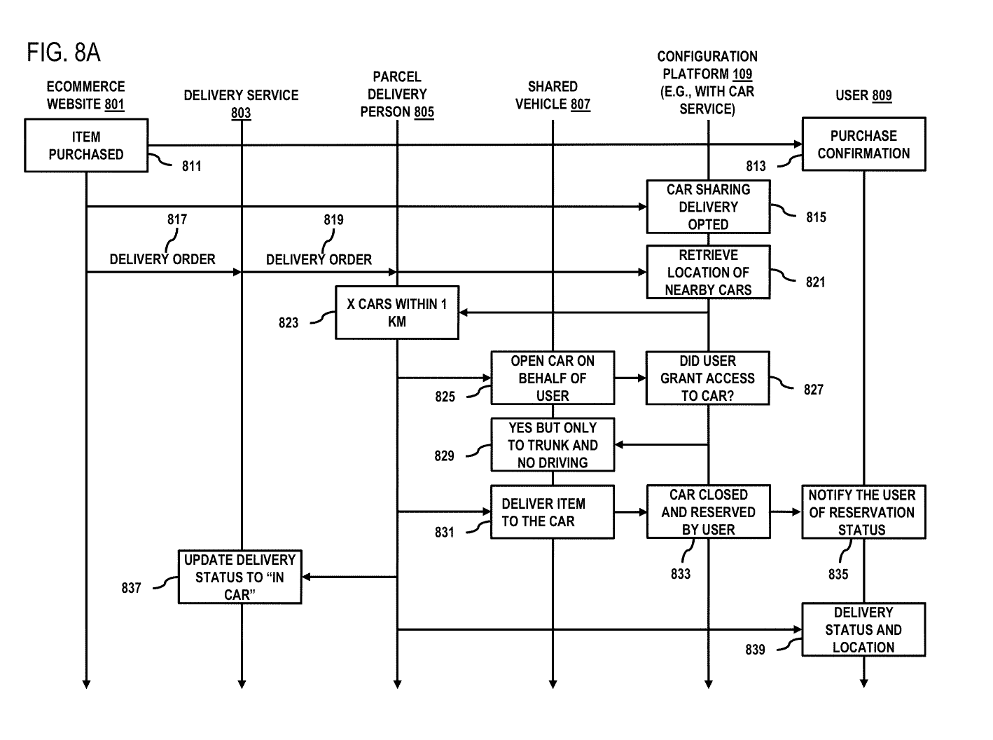

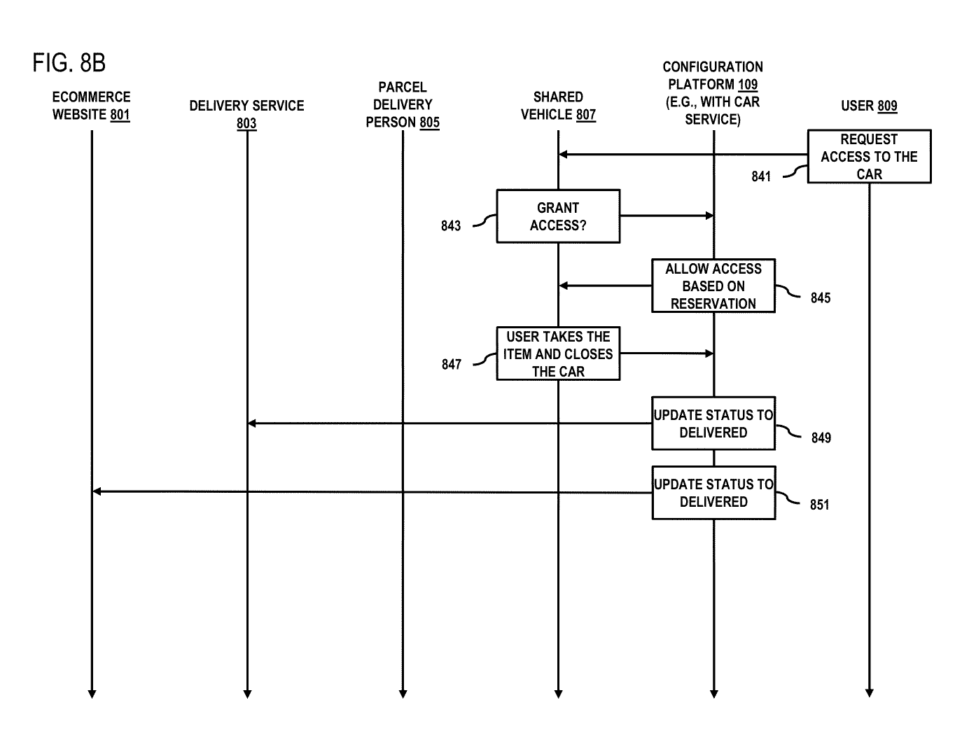

FIGS. 8A-8B are sequence diagrams utilized in the process of providing delivery of an item via established communications between an ecommerce website 801, a parcel delivery company 803, a parcel delivery person equipped with a parcel tracking/reading device 805, a shared vehicle or car 807 that is equipped/embedded with communication means similar to the UE 101, the configuration platform 109 configured with a car sharing service, and the UE 101 of the user 809, according to one example embodiment. In one example the parcel tracking/reading device 805 can be similar to the UE 101. In the example of FIGS. 8A and 8B, the configuration platform 109 comprises or is otherwise associated with a car sharing service or a rental car service that is configured to provide shared cars or vehicles for parcel delivery according to the various embodiments described herein. Additionally, in one scenario, a user 809 may be a consumer using a UE 101 to purchase items from an ecommerce website.

By way of example, a user 809 may purchase an item at the ecommerce website 801 as shown in process 811. In response, the ecommerce website 801 provides a confirmation of the purchase to the user 809 in process 813. In one embodiment, the confirmation includes the acceptance of the delivery terms by the user 809. For example, the delivery terms may comprise the mode of delivery, the time of delivery, the location of the delivery, an identification of the user's 809 subscription with the car sharing service, etc. In this example, the user opts for delivery via car sharing if needed or available at the time of delivery. Accordingly, the ecommerce website 801 notifies the configuration platform 109 that the user has selected the car sharing delivery option for the user's item (process 815). In one embodiment, the notification comprises a user identification, a delivery identification, the delivery location, the identification of the user's 809 subscription with the car sharing service and/or related delivery parameters.

As shown, the ecommerce vendor or website 801 may use a parcel delivery service 803 to deliver the item to the delivery location. To initiate delivery of the item, the ecommerce website transmits the delivery order for the item to the delivery service 803 (process 817) and ultimately to the parcel tracking/reading device 805 with the delivery person (process 819) who is in the field and will make the physical delivery of the item. In one embodiment, when the delivery person 805 is ready to make the delivery of the item and the user has opted for delivery via car sharing, the delivery person 805 (e.g., via a delivery management terminal such as a handheld or embedded device 101) can send a request to the configuration platform 109 (e.g., a car sharing service of the configuration platform 109) to retrieve the locations of one or more nearby shared vehicles or cars that are part of the car sharing service (process 821). These cars, for instance, can serve as possible candidate delivery locations for the user's item. The request/delivery order to the configuration platform 109 can comprise the delivery terms, the mode of delivery, the time of delivery, the location of the delivery, a parcel identification, a parcel type (such as size, weight, value, fragile, etc.), the identification of the user 809, the identification of the user's 809 subscription with the car sharing service, an identification of the delivery management terminal, or any combination thereof. Alternatively, the delivery service 803 can sent the request/delivery order to the configuration platform 109 (e.g., a car sharing service of the configuration platform 109) and then transmit the received information of the locations of the nearby shared vehicles or cars that are part of the car sharing service (process 821) to the delivery management terminal, i.e. the parcel tracking/reading device 805, such as a handheld or embedded device 101. Additionally, the configuration platform 109, after retrieving the locations of nearby shared vehicles or cars, can transmit the locations directly to the delivery management terminal 805 based on the delivery management terminal identification information.

For example, the configuration platform 109 can search for one or more nearby cars (e.g., shared vehicles of the car sharing service) that may be at a location within a predefined distance (e.g., 300 meters) of the user's location, for example if the platform 109 has substantially real-time location information of the user 809, or of the delivery location. In one embodiment, the car may be an autonomous car. In one embodiment, the configuration platform 109 can inform the parcel delivery company and/or the parcel delivery person 805 equipped with a parcel tracking/reading device, which possess information of the item, about information of the one or more nearby cars e.g., car's location, type, color, license plate, identification number, etc. (process 823). The delivery company 803 and/or the delivery person 805 can then select/reserve one or more of the identified nearby cars as the delivery location.

In one embodiment, the parcel delivery person 805 confirms the selection/reservation of the shared vehicle 807 by sending a request to the selected shared vehicle 807 to open the car on behalf of the user (process 825), wherein the request comprises the car information, the parcel identification, the parcel type (such as size, weight, value, fragile, etc.), the identification of the user 809, the identification of the user's 809 subscription with the car sharing service, the identification of the delivery management terminal, or any combination thereof. In one embodiment, on receipt of the request, the shared vehicle 807 queries the configuration platform 109 to verify that the users has opted for car sharing delivery and/or has the requisite account configuration (e.g., subscription) for the reserving the shared vehicle 807 for delivery (process 827). In one embodiment, the configuration platform 109 can further determine whether the user 809 has granted access to the shared vehicle 807 for delivery of a specific item, e.g. based on the parcel identification and/or the car information. In one further embodiment, the configuration platform 109 can further determine whether the user 809 has granted access to a specific shared vehicle 807 for delivery of the item. In one embodiment, the configuration platform 109 can also determine the specific access rights or parameters granted by the user and/or the car service. For example, the user can grant or deny full access to all or some compartments of the shared vehicle 807 as well as access to operate the shared vehicle 807 (e.g., drive, turn on, move, etc.). In this example, the user 809 has granted access to the trunk compartment only and has restricted driving operations. The configuration platform 109 sends these access rights to the shared vehicle 807 (process 829).

In process 831, the parcel delivery person 805 users the granted access rights (e.g., access to the trunk) to deliver the item to the trunk of the shared vehicle 807. In one embodiment, the shared vehicle 807 and/or the parcel delivery persons 805 can signal the configuration platform 109 that the delivery of the item to the shared vehicle 807 is complete and that the car is closed and secured (process 833). In one embodiment, the act or detection of the act of completing delivery to the shared vehicle 807 also initiates a reservation of the shared vehicle 807 via the car sharing service of the configuration platform 109 on behalf of the user for the delivery (e.g., for some specific time span). In process 835, the configuration platform 109 notifies the user of the reservation status of the shared vehicle 807 and/or the associated delivery of the item to the shared vehicle 807. Additionally, the configuration platform 109 may notify the user of the location of the selected car. In one embodiment, the configuration platform 109 may start charging from the user/user's account a delivery reservation fee as long as the car is further signed off the delivery reservation.

In one embodiment, on completing delivery the item to the shared vehicle 807, the delivery person 805 can signal the delivery service 805 to update the delivery status of the item to “in car” or other similar status designation to indicate the item is now within the shared vehicle 807 (process 837). At the same time, the delivery person 805 and/or the delivery service 803 can inform the user 809 of the delivery status of the item and/or the location of the selected car (process 839). In one embodiment, communication between the delivery management terminal, i.e. the parcel tracking/reading device 805 (such as a handheld or embedded device 101), and the shared vehicle 807 may happen over proximity communication means. By way of example, proximity communication means may comprise local wireless connection, such as Bluetooth™, wireless LAN (local area network), near field communication (NFC), infra-red communication, bar/QR code scanning, etc. or any combination thereof. Alternatively or additionally, the communication may happen over wireless telecommunication means. In one embodiment, the communication between the delivery service 803 and the shared vehicle 807 may happen over the wireless telecommunication communication means.

In one scenario, the configuration platform 109 may enable the delivery company 803 and/or the delivery person 805 to query availability of a user for delivery purposes. If user availability is confirmed, no further action is required. However, if the user is detected to be unavailable, the configuration platform 109 may divert the query to users' other vehicles, vehicles of friends and family members, and to car sharing/rental services. This allows the delivery company to query the delivery address/location prior to sending the delivering vehicle on its way. In another scenario, the configuration platform 109 may cause cost optimization of a shared vehicle or a rental vehicle used for accepting and storing the delivery. When a vehicle is optimized for cost, the vehicle is required for storing delivery for as short time period as possible. In such cases the location of the vehicle would be potentially closer to the user's current location, or along the user's upcoming route, etc. Further, the configuration platform 109 may cause the location of the vehicle to be optimized for convenience when it is the user's own vehicle or friend's vehicle. When a vehicle is optimized for convenience, the vehicle location would be usually close to user's home, office, friend's home, future/upcoming destination, or along the drive route of user (e.g., driving home after work and picking the delivery on the way). The optimization of location may also take in to account the delivery company's usual delivery route and match the route to the potential route of the user's vehicle and/or friend's vehicle and/or shared vehicle and/or rental vehicle. This may allow generating savings for the delivery company in addition to making safe delivery of the goods.

FIG. 8B illustrates a sequence diagram of the processes associated with a user retrieving an item delivered to the shared vehicle 807 as described with respect to the processes of FIG. 8A. In one embodiment, the user 809 can locate the shared vehicle 807 to which his or her item has been delivered (e.g., via a location provided by the configuration platform 109 and/or the delivery service 803). Accordingly, in process 841, the user requests access the shared vehicle 807 to retrieve the delivered item. For example, a user 809 with a UE 101 can communicate and negotiate access rights with the car, via some proximity communication means. Then, the shared vehicle 807 can send a request to the configuration platform 109 to determine whether the request user 809 should be granted access to the shared vehicle 807 for retrieval of the delivered item (process 843). The configuration platform 109 may then allow access to the user based on verification or authorization of the user 809 and/or the user's reservation of the shared vehicle 807 (process 845). For example, the configuration platform 109 may verify the name or other details of the user (e.g., access credentials) to allow access to the item placed in the car. The user picks the item from the car and closes the car (process 847). The shared vehicle 807 can then signal the configuration platform 109 that the user has accessed the vehicle 807 and retrieved the item. Subsequently, the configuration platform 109 provides the updated status of the delivery to the delivery service 803 (process 849) and/or the ecommerce website 801 (process 851). Further, the configuration platform 109 may stop charging the user/user's account the delivery reservation.

The processes described herein for providing delivery of item by using vehicles of a car sharing service may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

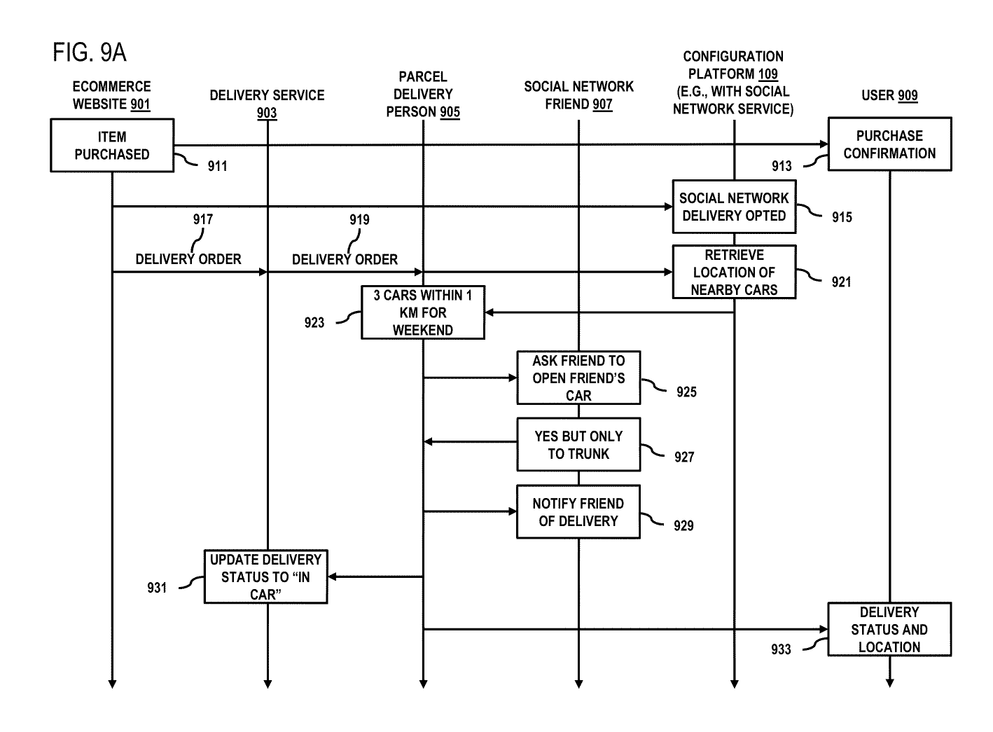

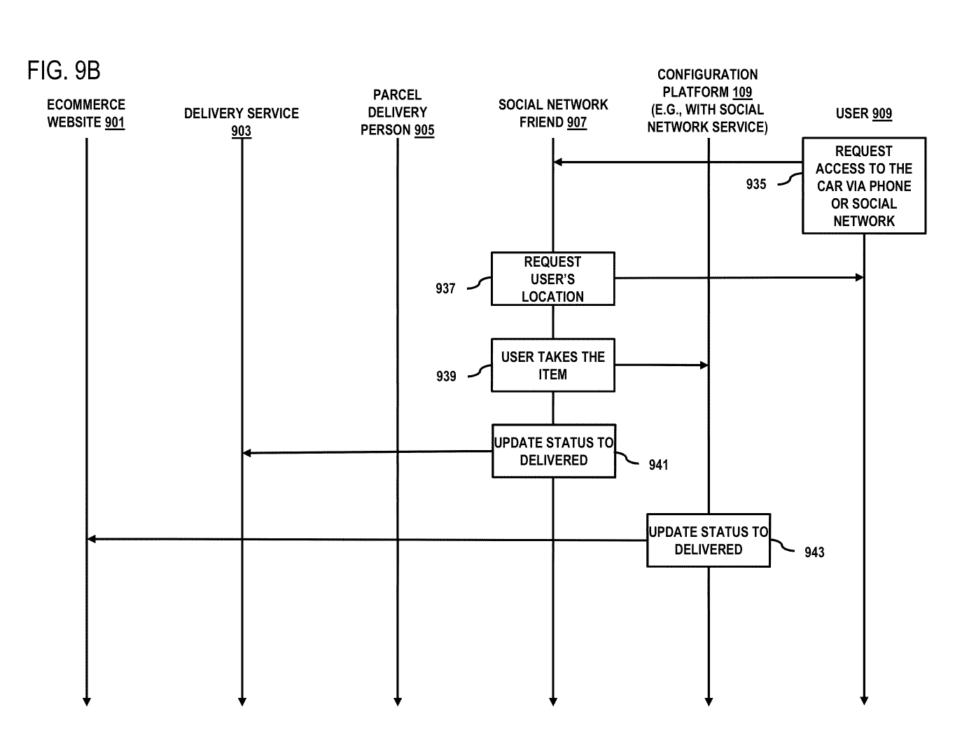

FIGS. 9A and 9B are sequence diagrams utilized in the process of providing delivery of an item via configuration platform 109 configured to provide shared cars or vehicles among social network contacts. The processes and signals of FIGS. 9A and 9B are similar to the processes of FIGS. 8A and 8B except that the car sharing service is replaced by social network-based car sharing in the configuration platform 109. As shown, the components of FIGS. 9A and 9B comprise an ecommerce website 901, a delivery company 903, a parcel delivery person equipped with a parcel tracking/reading device 905, a social network friend 907 equipped with an UE 101, a user 909, and the configuration platform 109, according to one example embodiment.

In one scenario, the user 909 may be a consumer using a UE 101 to purchase items from the ecommerce website 901. In one scenario, the item is purchased (process 911) at the ecommerce site 901 and the confirmation of the purchase is provided to the user 909 (process 913). In one embodiment, the confirmation comprises the acceptance of the delivery terms by the user. For example, the delivery terms comprises the mode of delivery, the time of delivery, location delivery, an identification of the user's 809 subscription with the car sharing service in the platform 109, etc. Further, the configuration platform 109 and/or the social networking service of the configuration platform 109 is notified with a user identification, a delivery identification, and/or the delivery location, that a social network contact car (hereinafter referred to as a friend's car) is opted for delivery by the user (process 915). In one embodiment, the notification comprises a user identification, a delivery identification, the delivery location, the identification of the user's 809 subscription with the car sharing service and/or related delivery parameters.

The ecommerce vendor or website 901 may use a parcel delivery service 903 (process 917) to deliver the item to the delivery location via the parcel delivery person 905 (process 919). In on embodiment, when initiating delivery, the parcel delivery person 905 sends a request to the configuration platform 109 or the social network service to retrieve the locations of the nearest cars belonging to the user 909's social network that are available for to accept delivery of the item (process 921). For example, the car may be at a location within a predefined distance (e.g., 300 meters) of the user 909's location or the delivery location and available for a specified duration (e.g., for the next two days).

Subsequently, the configuration platform 109 determines the location of the one or more cars and provides car's information, e.g. car's location, type, color, license plate, identification number, etc. to the delivery service. In one embodiment, the configuration platform 109 can inform the parcel delivery company 903 and/or the parcel delivery person 905 equipped with a parcel tracking/reading device, which possess information of the item, about the one or more nearby cars, for example the car's information, car's location, type, color, license plate, identification number, etc. (process 923). The delivery company 903 and/or the delivery person 905 can then select one of the nearby cars for the delivery. For example, the parcel delivery person 905 can send a request to a selected social network friend's 907 UE 101 to open or otherwise make the friend 907's car available to accept delivery of the item (process 925), wherein the request comprises the car information, the parcel identification, the parcel type (such as size, weight, value, fragile, etc.), the identification of the user 809, the identification of the user's 809 subscription with the car sharing service, the identification of the delivery management terminal, or any combination thereof. The social network friend 907 can then grant access rights to the friend 907's car that is equipped/embedded with communication means similar to the UE 101. In this example, the social network friend 907 grants rights to the parcel delivery person 905 to open the trunk of the shared car to accept delivery of the package (process 927). Alternatively, the granted rights can be sent to the friend vehicle, whereupon the parcel delivery person equipped with the parcel tracking/reading device 905 can access the friend vehicle and deliver the parcel. Thereafter, the parcel tracking/reading device 905 can inform the social network friend 907, the configuration platform 109, and/or the user 909 of the delivery.

On completing the delivery, the parcel delivery person 905 can signal the social network friend 907 that delivery is complete (process 929). The parcel delivery person 905 can also signal the delivery service 803 to update the delivery status of the item to “in car” or status to indicate that the item has been delivered to the social network friend 907's car (process 931). In addition, the parcel delivery person 805 and/or the delivery service 803 can notify the user 909 (e.g., via the social network service) of the delivery status of the item and/or the location of the social network friend 907's car. In an alternative embodiment the processes 925, 927 and 929 may be implemented in the configuration platform 109, e.g. if the friend 907 has allowed/opted this in his/her service settings. In another embodiment, e.g. if the friend 907 has allowed/opted this in his/her service settings, the processes 925, 927 and 929 may be replaced by, and/or amended with, the any of the processes of 825-835.

FIG. 9B illustrates a sequence diagram of a process for retrieving an item delivered to a social network friend's car. In process 935, the user 909 initiates a request to the social network friend 907 for access to the friend 907's car to retrieve the delivered item. By way of example, the user 909 may send this request via the social network service, a telephone call, or any other means of communication. On receiving the request, the social network friend 907 can request authentication information from the user 909. For example, the social network friend 907 can request the user 909's current location to verify that the user is located within proximity to the friend 907's car (process 937). In this way, if the friend 907 with the UI 101 can remotely unlock the car or otherwise provides access, the friend 907 can be assured that the user 909 is nearby. The user picks the item from the car and closes the car and informs that configuration platform 109 or social network service of the configuration platform 109 (process 939). In one embodiment, the friend 907's car is a connected car, the car can signal the delivery service 903 to update the delivery status of the item to delivered (process 941). In addition or alternatively, the configuration platform 109 and/or the social network service of the configuration platform 109 can signal the ecommerce site 901 to update the delivery status of the item to delivered (process 943). In alternative embodiment, the process (937-941) for retrieving the item delivered to the social network friend's car can be implemented in the configuration platform 109, e.g. if the friend 907 has allowed/opted this in his/her service settings. In another embodiment, e.g. if the friend 907 has allowed/opted this in his/her service settings, the processes 935-943 may be replaced by, and/or amended with, the any of processes of 841-851.

The processes described herein for providing delivery of item by using vehicles of a car sharing service may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

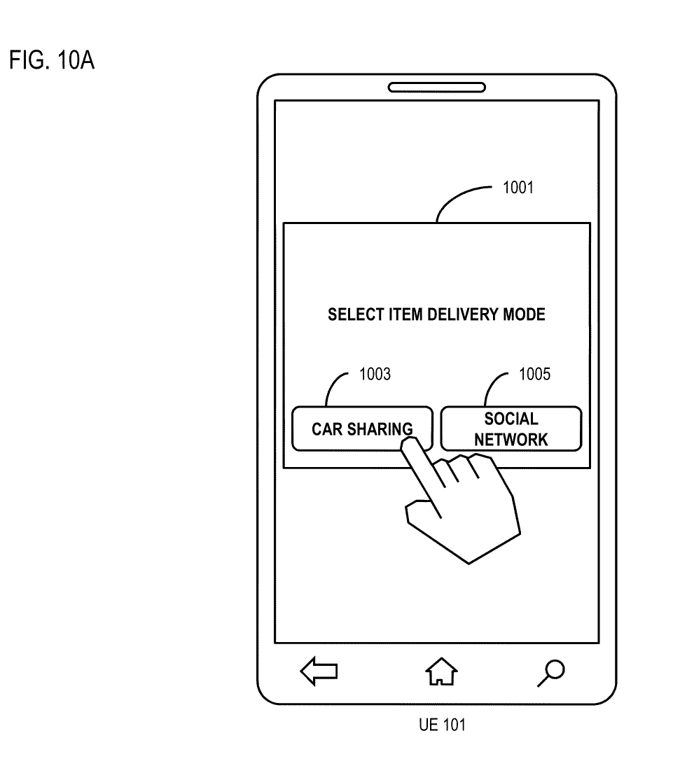

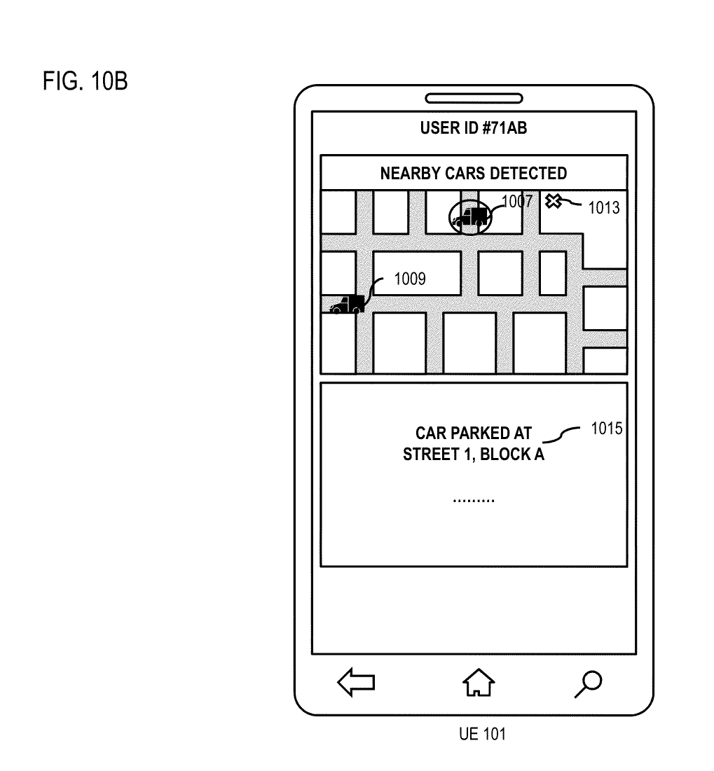

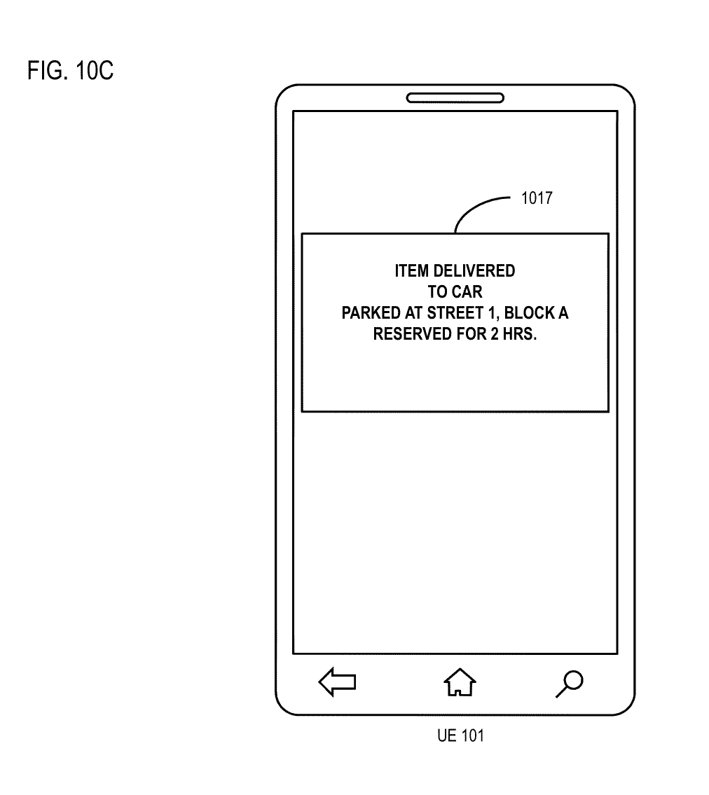

FIG. 10A is a user interface diagram that represents a scenario wherein vehicle sharing services may be utilized to deliver items to nearby vehicles instead of the delivery location, according to one example embodiment. In one scenario, FIGS. 10A-10C are user interface diagrams that represent a scenario wherein a user selects a car sharing service to receive delivery of item, according to one example embodiment. In FIG. 10A, the configuration platform 109 on receiving a purchase confirmation may show delivery option to the user. As depicted, the user may select a vehicle from one of a car sharing service 1003 and a social network 1005. As noted previously, a social networking contact of the user from the social network 1005 may be selected. In FIG. 10A, the user selects a car sharing service 1003 for delivery. In alternative embodiment, the user interface can be presented to an operator of the parcel delivery company and/or the parcel delivery person equipped with the parcel tracking/reading device.

FIG. 10B is a user interface diagram that represents a scenario wherein vehicles proximate to a delivery location are queried on availability, according to one example embodiment. As depicted in FIG. 10B, the configuration platform 109 determines one or more vehicles 1007 and 1009 that are available for reservation or subscription. In one embodiment, the vehicle 1007 that is nearest to the user's current location 1013 is selected for item delivery. Further, the vehicle location information 1015 may be presented on the UE 101. In one embodiment, the vehicle may be an autonomous car that can drive to the location nearest to the user. In alternative embodiment, the user interface can be presented to the operator of the parcel delivery company and/or the parcel delivery person equipped with the parcel tracking/reading device.

FIG. 10C is a user interface diagram that represents a scenario wherein at least one user is notified of delivery of an item, according to one example embodiment. As depicted in FIG. 10C, the configuration platform 109 also provides a notification 1017 related to the delivery of the item (e.g., “Item delivered to car parked at Street 1, Block A, Reserved for 2 Hrs.”). In one embodiment, the notification may be presented as an audio alert to the user.

The processes described herein for providing delivery of item by using vehicles of a car sharing service may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

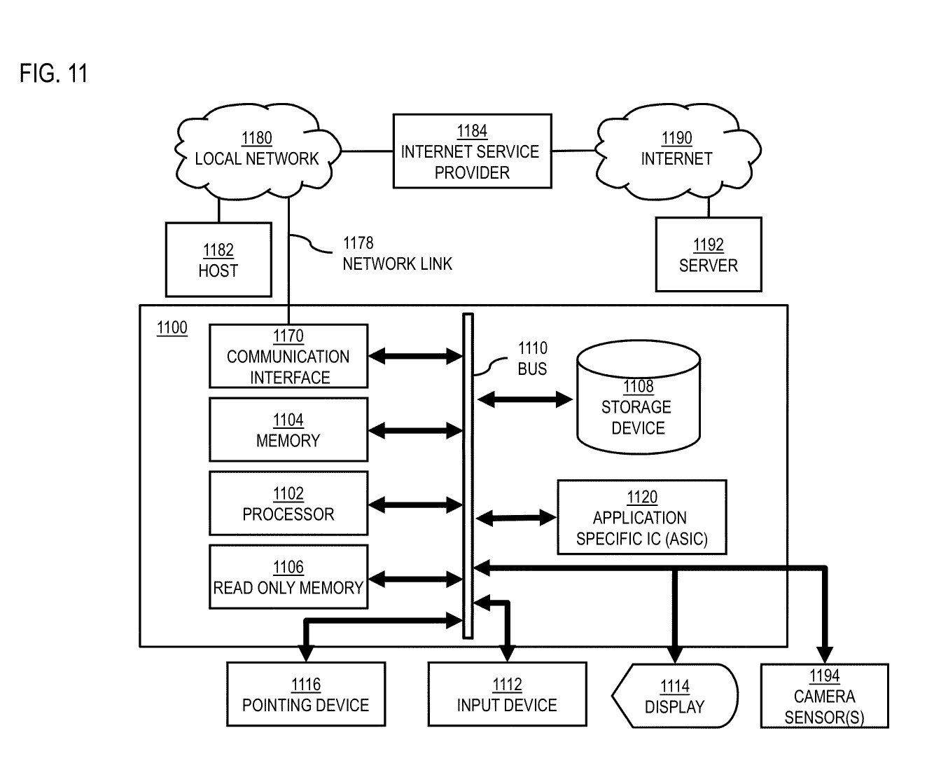

FIG. 11 illustrates a computer system 1100 upon which an embodiment of the invention may be implemented. Although computer system 1100 is depicted with respect to a particular device or equipment, it is contemplated that other devices or equipment (e.g., network elements, servers, etc.) within FIG. 11 can deploy the illustrated hardware and components of system 1100. Computer system 1100 is programmed (e.g., via computer program code or instructions) to select at least one vehicle nearby a delivery location that can accept delivery of an item for a user as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1100, or a portion thereof, constitutes a means for performing one or more steps of selecting at least one vehicle nearby a delivery location that can accept delivery of an item for a user.

A bus 1110 includes one or more parallel conductors of information so that information is transferred quickly among devices coupled to the bus 1110. One or more processors 1102 for processing information are coupled with the bus 1110.

A processor (or multiple processors) 1102 performs a set of operations on information as specified by computer program code related to selecting at least one vehicle nearby a delivery location that can accept delivery of an item for a user. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1100 also includes a memory 1104 coupled to bus 1110. The memory 1104, such as a random access memory (RAM) or any other dynamic storage device, stores information including processor instructions for selecting at least one vehicle nearby a delivery location that can accept delivery of an item for a user. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or any other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for selecting at least one vehicle nearby a delivery location that can accept delivery of an item for a user, is provided to the bus 1110 for use by the processor from an external input device 1112, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT), a liquid crystal display (LCD), a light emitting diode (LED) display, an organic LED (OLED) display, a plasma screen, or a printer for presenting text or images, and a pointing device 1116, such as a mouse, a trackball, cursor direction keys, or a motion sensor, for controlling a position of a small cursor image presented on the display 1114 and issuing commands associated with graphical elements presented on the display 1114, and one or more camera sensors 1194 for capturing, recording and causing to store one or more still and/or moving images (e.g., videos, movies, etc.) which also may comprise audio recordings. In some embodiments, for example, in embodiments in which the computer system 1100 performs all functions automatically without human input, one or more of external input device 1112, display device 1114 and pointing device 1116 may be omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of ASICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 107 for selecting at least one vehicle nearby a delivery location that can accept delivery of an item for a user to the UE 101.

The term “computer-readable medium” as used herein refers to any medium that participates in providing information to processor 1102, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1108. Volatile media include, for example, dynamic memory 1104. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1120.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system 1100 can be deployed in various configurations within other computer systems, e.g., host 1182 and server 1192.

At least some embodiments of the invention are related to the use of computer system 1100 for implementing some or all of the techniques described herein. According to one embodiment of the invention, those techniques are performed by computer system 1100 in response to processor 1102 executing one or more sequences of one or more processor instructions contained in memory 1104. Such instructions, also called computer instructions, software and program code, may be read into memory 1104 from another computer-readable medium such as storage device 1108 or network link 1178. Execution of the sequences of instructions contained in memory 1104 causes processor 1102 to perform one or more of the method steps described herein. In alternative embodiments, hardware, such as ASIC 1120, may be used in place of or in combination with software to implement the invention. Thus, embodiments of the invention are not limited to any specific combination of hardware and software, unless otherwise explicitly stated herein.

The signals transmitted over network link 1178 and other networks through communications interface 1170, carry information to and from computer system 1100. Computer system 1100 can send and receive information, including program code, through the networks 1180, 1190 among others, through network link 1178 and communications interface 1170. In an example using the Internet 1190, a server host 1192 transmits program code for a particular application, requested by a message sent from computer 1100, through Internet 1190, ISP equipment 1184, local network 1180 and communications interface 1170. The received code may be executed by processor 1102 as it is received, or may be stored in memory 1104 or in storage device 1108 or any other non-volatile storage for later execution, or both. In this manner, computer system 1100 may obtain application program code in the form of signals on a carrier wave.

Various forms of computer readable media may be involved in carrying one or more sequence of instructions or data or both to processor 1102 for execution. For example, instructions and data may initially be carried on a magnetic disk of a remote computer such as host 1182. The remote computer loads the instructions and data into its dynamic memory and sends the instructions and data over a telephone line using a modem. A modem local to the computer system 1100 receives the instructions and data on a telephone line and uses an infra-red transmitter to convert the instructions and data to a signal on an infra-red carrier wave serving as the network link 1178. An infrared detector serving as communications interface 1170 receives the instructions and data carried in the infrared signal and places information representing the instructions and data onto bus 1110. Bus 1110 carries the information to memory 1104 from which processor 1102 retrieves and executes the instructions using some of the data sent with the instructions. The instructions and data received in memory 1104 may optionally be stored on storage device 1108, either before or after execution by the processor 1102.

FIG. 12 illustrates a chip set or chip 1200 upon which an embodiment of the invention may be implemented. Chip set 1200 is programmed to selecting at least one vehicle nearby a delivery location that can accept delivery of an item for a user as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1200 can be implemented in a single chip. It is further contemplated that in certain embodiments the chip set or chip 1200 can be implemented as a single “system on a chip.” It is further contemplated that in certain embodiments a separate ASIC would not be used, for example, and that all relevant functions as disclosed herein would be performed by a processor or processors. Chip set or chip 1200, or a portion thereof, constitutes a means for performing one or more steps of providing user interface navigation information associated with the availability of functions. Chip set or chip 1200, or a portion thereof, constitutes a means for performing one or more steps of selecting at least one vehicle nearby a delivery location that can accept delivery of an item for a user.

In one embodiment, the chip set or chip 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1200 includes merely one or more processors and some software and/or firmware supporting and/or relating to and/or for the one or more processors.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to select at least one vehicle nearby a delivery location that can accept delivery of an item for a user. The memory 1205 also stores the data associated with or generated by the execution of the inventive steps.

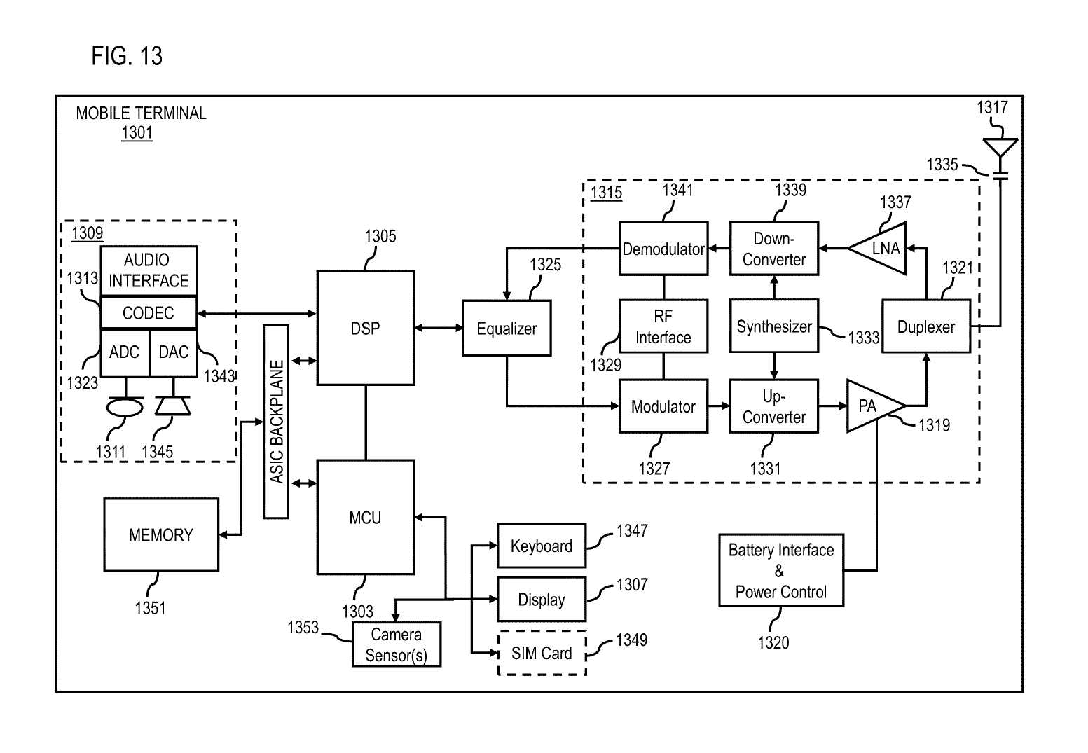

FIG. 13 is a diagram of exemplary components of a mobile terminal (e.g., handset) for communications, which is capable of operating in the system of FIG. 1, according to one embodiment. In some embodiments, mobile terminal 1301, or a portion thereof, constitutes a means for performing one or more steps of selecting at least one vehicle nearby a delivery location that can accept delivery of an item for a user. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile terminal functions that perform or support the steps of selecting at least one vehicle nearby a delivery location that can accept delivery of an item for a user. The display 1307 includes display circuitry configured to display at least a portion of a user interface of the mobile terminal (e.g., mobile telephone). Additionally, the display 1307 and display circuitry are configured to facilitate user control of at least some functions of the mobile terminal. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile terminal 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303 which can be implemented as a Central Processing Unit (CPU).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile terminal 1301 to select at least one vehicle nearby a delivery location that can accept delivery of an item for a user. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the terminal. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile terminal 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable storage medium known in the art. The memory device 1351 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1349 carries, for instance, important information, such as the cellular phone number, the carrier supplying service, subscription details, and security information. The SIM card 1349 serves primarily to identify the mobile terminal 1301 on a radio network. The card 1349 also contains a memory for storing a personal telephone number registry, text messages, and user specific mobile terminal settings.

Further, one or more camera sensors 1353 may be incorporated onto the mobile station 1301 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
determining a request for at least one delivery of at least one item to at least one delivery location associated with at least one user;
determining one or more vehicles that are capable of accepting the at least one delivery of the at least one item as a substitute to the at least one delivery location;
causing, at least in part, a selection of at least one vehicle from the one or more vehicles; and
causing, at least in part, a granting of an access to the at least one selected vehicle for accepting the at least one delivery of the at least one item.

2. A method of claim 1, wherein the one or more vehicles are associated with at least one car sharing service, at least one social networking contact of at least one user, one or more autonomous vehicles, or a combination thereof.

3. A method of claim 2, further comprising:
determining subscription status information associated with the at least one car sharing service for the at least one user,
wherein the granting of the access to the one or more vehicles, the at least one delivery of the at least one item, or a combination thereof is based, at least in part, on the subscription status information.

4. A method of claim 1, wherein the granting of the access comprise, at least in part, an access to one or more compartments of the at least one selected vehicles without an access to operate the at least one selected vehicle.

5. A method of claim 2, further comprising:
determining which of the one or more vehicles associated with the at least one car sharing service, the at least one social networking contact of at least one user, the one or more autonomous vehicles, or a combination thereof to use for the at least one delivery based, at least in part, on one or more characteristics of the at least one item,
wherein the at least one or more characteristics comprise, at least in part, a price, a size, a fragility, a perishability, or a combination thereof.

6. A method of claim 1, further comprising:
determining the one or more vehicles based, at least in part, on a proximity to the at least one delivery location, at least one current location of the at least one user, at least one future location of the at least one user, or a combination thereof.

7. A method of claim 6, further comprising:
determining the at least one current location of the at least one user, the at least one future location of the at least one user, or a combination thereof based, at least in part, on scheduling information, calendar information, or a combination thereof.

8. A method of claim 1, further comprising:
determining the one or more vehicles based, at least in part, on scheduling information, calendar information, or a combination thereof associated with the one or more vehicles, at least one owner of the one or more vehicles, or a combination thereof so that the scheduling information, the calendar information, or a combination thereof coincides with at least one anticipated delivery time.

9. A method of claim 1, further comprising:
determining a reservation of the at least one selected vehicle for the at least one delivery of the at least one item, and
causing, at least in part, an initiation of the at least one delivery of the at least one item to the one or more vehicles based, at least in part, on a determination that the at least one user is not located at the at least one delivery location.

10. A method of claim 1, further comprising:
causing, at least in part, a relay of the at least one delivery of the at least one item from the one or more vehicles to one or more other vehicles if the one or more vehicles moves, becomes unavailable, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine a request for at least one delivery of at least one item to at least one delivery location associated with at least one user;
determine one or more vehicles that are capable of accepting the at least one delivery of the at least one item as a substitute to the at least one delivery location;
cause, at least in part, a selection of at least one vehicle from the one or more vehicles; and
cause, at least in part, a granting of an access to the at least one selected vehicle for accepting the at least one delivery of the at least one item.

12. An apparatus of claim 11, wherein the one or more vehicles are associated with at least one car sharing service, at least one social networking contact of at least one user, one or more autonomous vehicles, or a combination thereof.

13. An apparatus of claim 12, wherein the apparatus is further caused to:
determine subscription status information associated with the at least one car sharing service for the at least one user,
wherein the granting of the access to the one or more vehicles, the at least one delivery of the at least one item, or a combination thereof is based, at least in part, on the subscription status information.

14. An apparatus of claim 1, wherein the granting of the access comprises, at least in part, an access to one or more compartments of the at least one selected vehicles without an access to operate the at least one selected vehicle.

15. An apparatus of claim 12, wherein the apparatus is further caused to:
determine which of the one or more vehicles associated with the at least one car sharing service, the at least one social networking contact of at least one user, the one or more autonomous vehicles, or a combination thereof to use for the at least one delivery based, at least in part, on one or more characteristics of the at least one item,
wherein the at least one or more characteristics comprise, at least in part, a price, a size, a fragility, a perishability, or a combination thereof.

16. An apparatus of claim 11, wherein the apparatus is further caused to:
determine the one or more vehicles based, at least in part, on a proximity to the at least one delivery location, at least one current location of the at least one user, at least one future location of the at least one user, or a combination thereof.

17. An apparatus of claim 16, wherein the apparatus is further caused to:
determine the at least one current location of the at least one user, the at least one future location of the at least one user, or a combination thereof based, at least in part, on scheduling information, calendar information, or a combination thereof.

18. A computer-readable storage medium carrying one or more sequences of one or more instructions which, when executed by one or more processors, cause an apparatus to at least perform the following steps:
determine a request for at least one delivery of at least one item to at least one delivery location associated with at least one user;
determine one or more vehicles that are capable of accepting the at least one delivery of the at least one item as a substitute to the at least one delivery location;
cause, at least in part, a selection of at least one vehicle from the one or more vehicles; and
cause, at least in part, a granting of an access to the at least one selected vehicle for accepting the at least one delivery of the at least one item.

19. A computer-readable storage medium of claim 18, wherein the one or more vehicles are associated with at least one car sharing service, at least one social networking contact of at least one user, one or more autonomous vehicles, or a combination thereof.

20. A computer-readable storage medium of claim 19, wherein the apparatus is further caused to perform:
determining subscription status information associated with the at least one car sharing service for the at least one user,
wherein the granting of the access to the one or more vehicles, the at least one delivery of the at least one item, or a combination thereof is based, at least in part, on the subscription status information.

21.-48. (canceled)
